(19) United States
(12) Patent Application Publication
(10) Pub. No.: US 2014/0210575 A1
(43) Pub. Date: Jul. 31, 2014

(54) ELECTRICALLY OPERATED BRANCH CIRCUIT PROTECTOR

(71) Applicant: James J. Kinsella, Pleasant View, TN (US)

(72) Inventor: James J. Kinsella, Pleasant View, TN (US)

(21) Appl. No.: 13/751,780

(22) Filed: Jan. 28, 2013

(51) Int. Cl. H01H 77/06

(52) U.S. Cl. CPC H01H 77/06
USPC 335/8

(57) ABSTRACT

Electrical operation of circuit breakers utilizing a straight pull dc magnet system with positive means of locking in OFF position is provided. The operating dynamics have advantages in fault coordination and discrimination for motor branch circuits. The construction offers physical and economic advantages in control solutions.

### TECHNICAL FIELD

The following disclosure relates in general to electrical distribution and more particularly to an electrically operated branch circuit protector.

### BACKGROUND

Motor branch circuits are differentiated from most other electrical distribution due to the nature of their loads and environment. Electric motors are a vital part of manufacturing and service operations. They are expensive and any down time has major economic implications. Personnel safety and facility protection is always a major concern.

For motor branch circuit protection, the present state of the art is to utilize conventional circuit breakers, with thermal trip elements removed.

With the advent of a new generation of contactors having pulse width modulated dc coils and low inertia magnets, conventional circuit breakers are too slow in operation to protect the motor contactors from welding or even exploding under fault conditions.

Existing circuit breakers are mechanical in operation. Thus when safety interlocking is required for enclosures, expensive mechanical means are needed. Remote operation is not possible without the use of additional add on accessories.

### SUMMARY

Electrical operation of a circuit breaker means allows for the same basic protection as that afforded by conventional mechanical circuit breakers while giving the advantages of performing the actuation functions without mechanical means. An electrically operated branch circuit protector (EOBCP) integrated in a single enclosure that includes an electromagnetic assembly for use in a contact interruption system.

### BRIEF DESCRIPTION OF THE DRAWINGS

For a more complete understanding of the present disclosure and the advantages thereof, reference is now made to the following description taken in conjunction with the accompanying drawings, wherein like reference numerals represent like parts, in which:

FIG. 1 illustrates a typical 3 phase motor arrangement;

FIG. 2 illustrates a 3 phase motor arrangement with the poles in individual enclosures;

FIG. 3 illustrates an assembly of a 3 pole configuration;

FIG. 4 illustrates a cross section through the assembly;

FIG. 5 illustrates a detail of the moving contact assemble.

### DETAILED DESCRIPTION

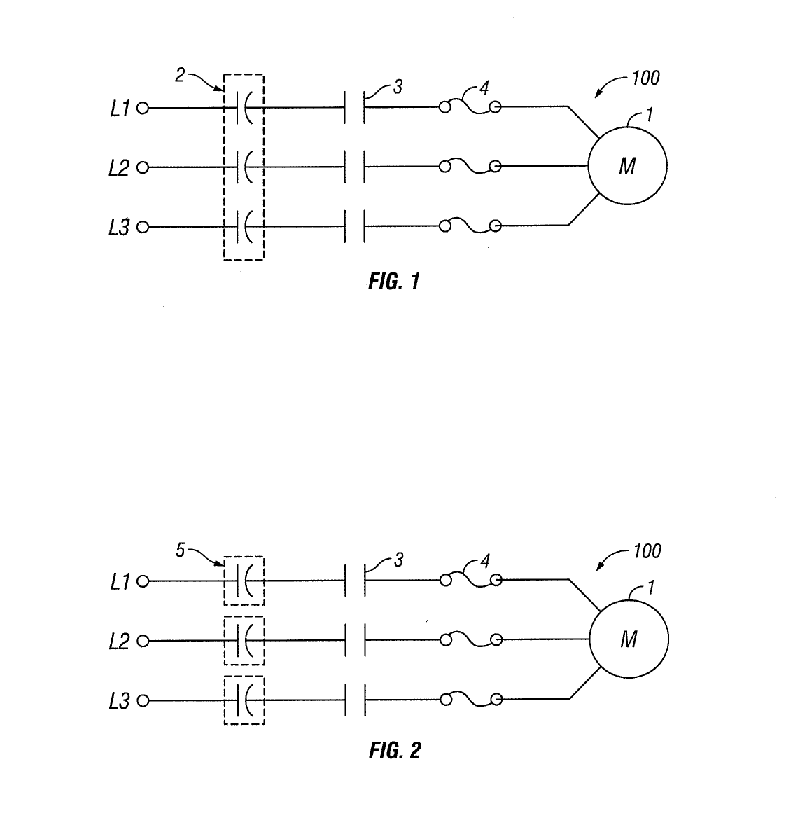

FIG. 1 illustrates a 3-phase motor arrangement 100. Motor arrangement 100 includes a motor 1 and a circuit breaker 2 that provides disconnection and protection. A contactor 3 performs the switching function. Motor arrangement 100 also includes a motor overload protective relay 4. In this example, each pole 5 of circuit breaker 2 is shown in a common assembly.

FIG. 2 illustrates a 3-phase motor arrangement with the same motor arrangement 100 as in FIG. 1 but with the poles 5 in individual enclosures.

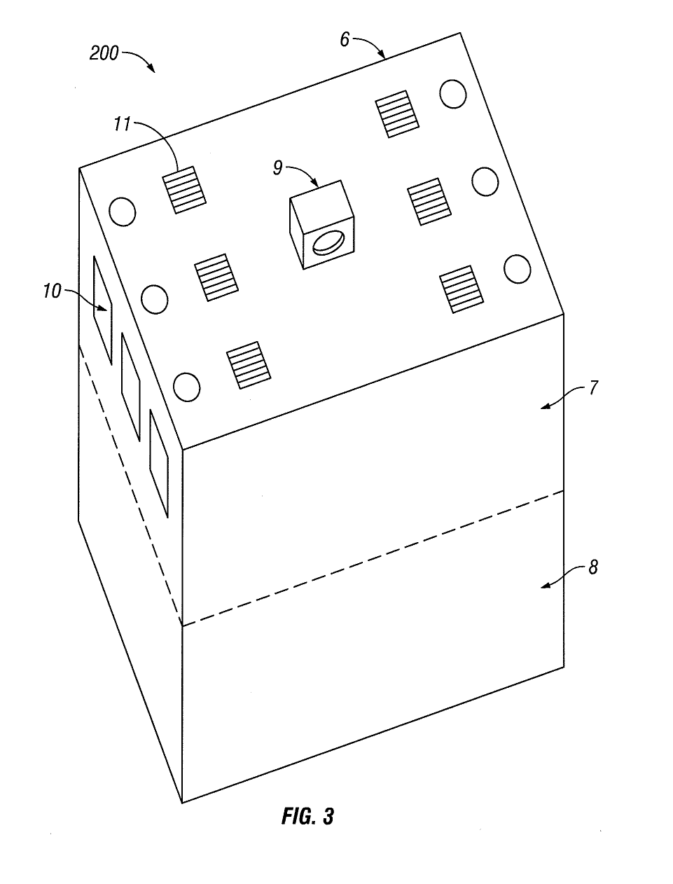

FIG. 3 shows an electrically operated branch circuit protector (EOBCP) 200 of a 3-pole configuration within an enclosure 6. In the lower part of the EOBCP 200 is an electromagnetic assembly 8. In the upper part of the EOBCP 200 are the contact assemblies 7 with their terminations 10 and vents 11 for arcing gases. An extension of the moving contact carrier 9 is also shown.

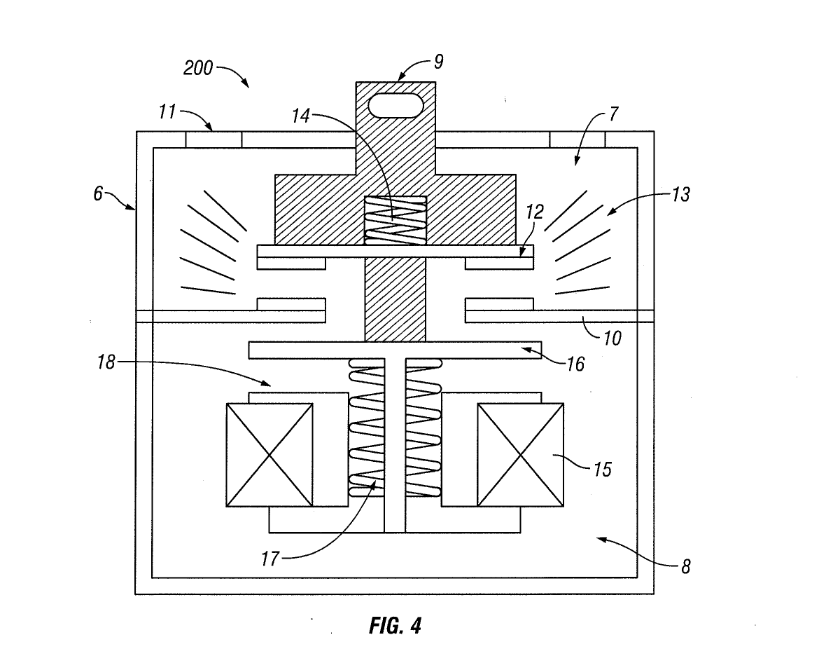

FIG. 4 is a cross section through EOBCP 200 of FIG. 3. One or more sets of moving contacts 12 and arc splitters 13 are provided in EOBCP 200. A spring 14 provides pressure to the contacts when they are closed. Moving contact carrier 9 is shown extending through the enclosure. Fixed contacts 20 are attached to terminations 10. Electromagnetic assembly 8 includes a coil 15 which, when energized, causes the magnet armature 16 to close carrying with it the moving contacts 12 so as to open and close the contacts 12. A magnet frame 18 provides, with the coil 15, magnetic flux so as to attract the armature 16. A spring 17 returns the armature 16 and its attached moving contact 12 to the open position when the magnet is switched off.

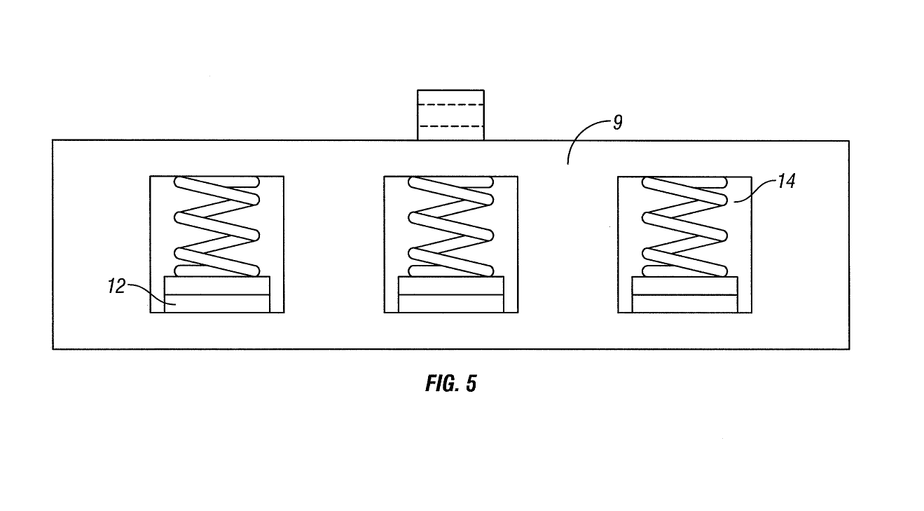

FIG. 5 shows a detail of the moving contact assembly whose main elements are the moving contacts 12, contact springs 14, and plastic contact carrier 9 that extends through the enclosure to provide positive mechanical interfacing means including safety locking in the off position. Though the number of contacts is shown as three which is the most likely number, one and two contact designs are also possible. These single or multiple contact arrangements may be connected in parallel so as to operate as a single pole.

### Coil Control

One of the keys to the design of a circuit breaker based on electromagnetic contactor principles is the method of coil control. This disclosure describes a circuit breaker that uses an enhanced controlled dc magnet system. One reason to do this is that it facilitates the use of anti-welding contact materials identical to those that are currently used in similar current rated circuit breakers.

Accordingly, this pulse width modulated dc coil control has a number of key functions. A first function controls the actuation of EOBCP 200 and to control the coil current to cause a no-bounce closure. A second function is to provide enough contact pressure to permit the use of contact materials suitable for both circuit breaker and contactor functions. A third function is to reduce the coil current to the just-hold level in order to minimize the holding current, giving a small thermal footprint. The just hold coil current allows the magnet/contact system to be forced open under the influence of fault currents but is insufficient to close even in the short event times of fault currents. A fourth function is to allow for a low inertia magnetic armature so that opening is similar to that of dc operated contactors. A fifth function permits a very compact overall size design compatible with dc operated contactors. A sixth function allows for cost effective remote operation so as to optimize programmable logic controller and computer based systems. A seventh function facilitates electrical door interlocking for combination starters and motor control centers. An eighth function provides for mechanical and electro-dynamical similarity between EOBCP 200 and motor starter contact systems so that any short circuit forces on the contact systems will be similar.

### Straight Pull Moving Contact System

The second key aspect is a simple straight pull system with direct control of the moving contact bar without the usual complex mechanisms seen in conventional circuit breakers. This enables a design physically compatible with contactors and an ability to share many mechanical parts. The straight pull system facilitates a simple add-on electrically operated auxiliary electromagnet, a directly operated mechanical interlock or operator with known safety advantages, known as positive operation which is not possible with existing circuit breakers. A double break contact structure with its known advantages over single break is also provided. The main contact gap will be sufficient to give disconnect/dielectric distances so as to conform to relevant standards and safety requirements. The molded moving contact assembly will have a robust extension through the front of the contactor to provide a mechanical interface for positive lock OFF.

It is a known fact that current-carrying contacts, with geometry similar to that used in conventional contactors, blow open when the current that they are carrying exceeds a certain threshold. In conventional contactors with a high inertia ac magnet, the magnet remains closed, or in some cases recloses, after the contacts blow open. This can result in the main current carrying contacts welding when they re-close on the fault current. This blow open level is a function of load current (typically 12 to 16 times continuous rated current), contact geometry, and contact spring rate.

### Coordinated Operation

The fourth key to this disclosed circuit breaker is that the armature (moving part of the main closing magnet) is held closed by a precisely controlled dc coil current to a safe level above the just hold level. The effect of a fault current will be to blow open the main contacts. This will result in a hammer blow to the armature through the moving contact assembly. A short circuit di/dt current sensor commands a switch off of the coil current in the high-speed mode. This opening is aided by the magnet return spring and the contact springs. Once the magnet has started to open, the flux in the magnetic gap decreases rapidly, thus exerting less pull and the moving contact structure opens.

This operation provides for a number of features. The pulse width modulated dc coil control facilitates the blowing open of the armature and moving contact assembly so as to avoid contact welding. The magnetic circuit will open and not reclose mitigating against main contact welding. The main contact gap will be sufficient to give disconnect/dielectric distances so as to conform to relevant standards and safety requirements. A completely electric interlocking system may be employed for safety interlocking of electrical enclosure doors. A much simplified direct mechanical operating and interlocking system is possible. An electronic/sensor-based system can be employed rather than the present over current trips used in conventional circuit breakers. This permits progressive faults to be managed so as to maximize up time and prevent costly damage to equipment.

### Coordinated Dynamic Operation

If the motor contactor has a similar electromagnet and contact structure to that of EOBCP 200, then the two switching devices can be coordinated in response to a short circuit. This means that all of the series contacts in the main motor branch power circuit, which will typically be one or more contactors and one or more EOBCP 200, will blow apart in a similar fashion so that all contacts will assist EOBCP 200 in breaking short circuit currents in a harmonized coordinated way. In a typical starter, the load contactor and branch circuit breaker would have coordinated blow open levels assisting in the breaking event.

Thus in a direct-on-line motor starter, there are 4 contact breaks in series for ground faults and 8 for line-to-line faults, ensuring survivability of the contactors for further service.

Other benefits

The above protector allows the reuse of many parts from contactors already in volume production. To aid with keeping parts to a minimum, individual switches may use one or more contact structures so as to form multiple contact poles. In some cases, these contacts may be connected in parallel.

For high current ratings, isolation of single pole construction permits lower tooling costs and facilitates pole to pole electrical and magnetic isolation where needed.

The similar size and geometry for both contactors and EOBCP 200 will allow for simplified control panel layout and power cabling. Safety contactor functions can be done with a single device rather than with two as is common today. The smaller footprint will allow for smaller enclosures, lower panel projection, and reduced heat dissipation.

EOBCP 200 is well suited in size, performance, and cost for protecting the line side of invertors and variable frequency drives. They will also be ideal for isolating the load side of invertors and variable speed drives.

When used in place of a standard circuit breaker, EOBCP 200 has the potential of simplifying the traditional through-the-door mechanically interlocked operator. Also, the combination of electrical and mechanical operation creates new opportunities for cost reduction and safety for enclosed equipment. Electrical interlocking is simpler and provides two levels of safety. The first is by means of a door switch and the second by means of a lockable handle on the switch mechanism.

EOBCP 200 allows the circuit breaker function to be used in a novel way due to its dc coil control. Rather than a hard close onto a possible fault, the circuit is tested with a voltage pulse, akin to dabbing a hot surface with the hand to see if it safe to touch. The aim is to minimize damage to the motor, its control and feeder cables. This user selectable testing can be invoked at any appropriate time and takes only a few seconds. This is implemented when a motor start is needed for the first time or after maintenance. When motors that run for extended periods and are started infrequently, the protection may be used on every start.

For example, FIGS. 1 and 2 show main circuits for a 3-phase motor. The first step is to turn on the control power. Then, the motor contactor 3 is switched on.

Single pole EOBCP.

EOBCP 200 is momentarily switched on so as to apply a pulse of power to the motor and feeding circuit. Any resultant current flow is instantly analysed to see if a fault exists. If not, then the contactor is turned OFF, EOBCP 200 is turned fully ON, and a normal start proceeded with.

3-pole EOBCP

In a 3-phase application, the contactor 3 is energized. For earth faults, each of EOBCP 200 poles is pulsed in rotation and any current flow is measured. Current flow indicates a leakage to earth and a likely fault. For line faults, each pair of EOBCP 200 poles is momentarily closed in rotation to apply single phase line voltage test pulses to the branch circuit. Thus L1-L2, L2-L3, and L3-L1 connections are tested. Normal inrush single phase current will flow. However, a short circuit which is an abnormal condition will cause currents to flow that are easily recognized and determined to be faults. If all is well, EOBCP 200 is closed and a normal start is proceeded with by a normal close of contactor 3.

### Applications

One very significant application is as a contactor/circuit breaker whereby it can be used as a single switch starter (combining the switching functions of circuit breakers and contactors in one device) both for stand-alone Pump Panels, Combination Starters, and Motor Control Centers. Thus, in FIGS. 1 and 2, the contacts designated 2 and 3 can be combined into a single set.

Where needed all of the 2-step and pulse testing POW functions can be utilized within such applications with the size and cost advantages afforded by this single device. Note that a means is provided to derive control circuit power from the line. Significant advantages accrue due to the physical characteristics of EOBCP 200 being compatible with contactors, particularly the power contact terminations.

### Sequence

If a secondary safety latch on EOBCP 200 is locked OFF, this is removed. The enclosure door is closed and a power on control switch is operated so as to mechanically latch the door and enable power to the dc control. If selected, the pulse testing of the power circuit would be invoked in a manner selected by the user. When the motor starting is required, means to do so is enabled either conventionally direct on line or the POW 2 step starting sequence is invoked. All protective functions incorporated in the control are enabled.

What is claimed is:

1. An electrically operated branch circuit protector, comprising:
an enclosure;
one or more electromagnetically controlled poles within the enclosure;
an electromagnetic assembly within the enclosure operable to place the poles into an on position when engaged;
a spring within the enclosure operable to return the pole to an off position when the electromagnetic assembly is disengaged.

2. The electrically operated branch circuit protector of claim 1, wherein a number of electromagnetically controlled poles is three to provide a three-pole protector.

3. The electrically operated branch circuit protector of claim 2, wherein the poles or connected in parallel.

4. The electrically operated branch circuit protector of claim 2, wherein the electromagnetic assembly is operable to pulse any combination of one or more poles for testing of the protector.

5. The electrically operated branch circuit protector of claim 2, wherein the poles are disposed in a common assembly.

6. The electrically operated branch circuit protector of claim 1, wherein the electromagnetic assembly includes a circuit operable to control engagement and disengagement of the electromagnetic assembly.

7. The electrically operated branch circuit protector of claim 1, wherein the pole includes an interface extending outside of the enclosure.

8. The electrically operated branch circuit protector of claim 7, wherein the interface includes a locking mechanism.

9. The electrically operated branch circuit protector of claim 8, wherein the locking mechanism is operable to place the pole in an off position.

10. The electrically operated branch circuit protector of claim 1, wherein the enclosure includes a switch to allow operation of the electromagnetic assembly.

11. The electrically operated branch circuit protector of claim 1, wherein the enclosure includes a door that, when secured, allows operation of the electromagnetic assembly.
